(19) United States
(12) Patent Application Publication
(10) Pub. No.: US 2025/0358394 A1
(43) Pub. Date: Nov. 20, 2025

(54) CONTROL DEVICE, CONTROL METHOD, AND CONTROL PROGRAM

(71) Applicant: FUJIFILM Corporation, Tokyo (JP)

(72) Inventor: Kazuyuki ITAGAKI, Saitama-shi (JP)

(73) Assignee: FUJIFILM Corporation, Tokyo (JP)

(21) Appl. No.: 19/286,490

(22) Filed: Jul. 31, 2025

Related U.S. Application Data
(63) Continuation of application No. PCT/JP2024/004989, filed on Feb. 14, 2024.

(30) Foreign Application Priority Data
Mar. 3, 2023 (JP) 2023-032759

(51) Int. Cl. H04N 9/31

(52) U.S. Cl. CPC H04N 9/3179

(57) ABSTRACT

A control device includes a processor. The processor is configured to instruct a projection device to project a first image including a plurality of markers for adjusting a projection position, perform a first detection process of detecting the plurality of markers based on first captured image data that is obtained by capturing a projection image of the first image, and perform a second detection process of detecting, in a case where there is an undetected marker that is not detected in the first detection process, at least the undetected marker.

### CROSS-REFERENCE TO RELATED APPLICATIONS

This is a continuation of International Application No. PCT/JP24/004989 filed on Feb. 14, 2024, and claims priority from Japanese Patent Application No. 2023-032759 filed on Mar. 3, 2023, the entire content of which is incorporated herein by reference.

### BACKGROUND OF THE INVENTION

### 1. Field of the Invention

The present invention relates to a control device, a control method, and a computer-readable medium.

### 2. Description of the Related Art

JP2014-007484A discloses a projection system comprising an imaging control unit that causes an imaging unit to image a guide projected from a projector onto a screen, and an image analysis unit that detects the guide from a captured image of the imaging unit, in which the imaging control unit changes a setting of an imaging condition and causes the imaging unit to execute imaging again in a case where the guide cannot be detected from the captured image by the image analysis unit.

JP2021-114685A discloses an image projection system including a video playback device, a projection device, a control device, an imaging device, and a screen, in which a marker image for adjusting a misregistration of a projected image is input to the projection device while being superimposed on an original image. According to the image projection system, the marker image is set to a gradation value that is difficult to be visually recognized by a user, so that a projection position can be adjusted during image projection. In addition, a process of generating a marker-extracted image from a captured image acquired by the imaging device is performed by generating an averaged image in which a plurality of duplicated captured images are shifted and superimposed and removing a low-frequency component.

JP2009-064110A discloses an image capturing device that performs a user operation detection behavior for removing an input image (projected image) and a background image (star-shaped background pattern) from a captured image in order to detect a hand of a user from the captured image.

### SUMMARY OF THE INVENTION

One embodiment according to the technology of the present disclosure provides a control device, a control method, and a computer-readable medium capable of accurately adjusting a projection position of a projection device.

(1)

A control device comprising:
a processor,
in which the processor is configured to
   instruct a projection device to project a first image including a plurality of markers for adjusting a projection position,
   perform a first detection process of detecting the plurality of markers based on first captured image data that is obtained by capturing a projection image of the first image, and
   perform a second detection process of detecting, in a case where there is an undetected marker that is not detected in the first detection process, at least the undetected marker.
      (2)

The control device according to (1),
in which a color of the marker is a first color corresponding to a first wavelength range,
the processor is configured to perform, as the second detection process, a detection process of the undetected marker based on first color image data consisting of a component of the first color in the first captured image data and second color image data consisting of a component of a second color in the first captured image data, and
the second color is a color corresponding to a second wavelength range that partially overlaps with the first wavelength range.
   (3)

The control device according to (2),
in which the processor is configured to perform the detection process of the undetected marker based on a subtraction process between the first color image data and the second color image data.
   (4)

The control device according to (3),
in which the processor is configured to
   calculate a coefficient based on the first color image data and the second color image data, and
   perform the detection process of the undetected marker based on the subtraction process between the first color image data and the second color image data that is corrected by the coefficient.
      (5)

The control device according to (1),
in which the processor is configured to, as the second detection process,
   instruct the projection device to project a second image including a marker obtained by excluding the undetected marker from the plurality of markers, and
   perform a detection process of the undetected marker based on the first captured image data and second captured image data that is obtained by capturing a projection image of the second image.
      (6)

The control device according to (5),
in which the processor is configured to perform the detection process of the undetected marker based on a subtraction process between the first captured image data and the second captured image data.
   (7)

The control device according to (1),
in which the processor is configured to, as the second detection process,
instruct the projection device to project a third image including a plurality of markers in which at least any one of a position, an orientation, or a shape is different from a position, an orientation, or a shape of the plurality of markers in the first image, and
perform a detection process of the undetected marker based on third captured image data that is obtained by capturing a projection image of the third image.
   (8)

The control device according to (7),
in which the plurality of markers included in the third image are disposed to avoid a thing present on a projection surface for the projection image of the first image.
   (9)

The control device according to (8),
in which the processor is configured to detect the thing based on the first captured image data.
   (10)

The control device according to any one of (7) to (9),
in which there are reference points corresponding to the plurality of markers in the first image, and
the plurality of markers in the third image are in a relationship, in which at least any one of movement, rotation, or deformation is performed on at least the undetected marker in the first image with reference to the reference points, with the undetected marker.
   (11)

A control method of a control device including a processor, the control method comprising:
instructing a projection device to project a first image including a plurality of markers for adjusting a projection position,
performing a first detection process of detecting the plurality of markers based on first captured image data that is obtained by capturing a projection image of the first image, and
performing a second detection process of detecting, in a case where there is an undetected marker that is not detected in the first detection process, at least the undetected marker.
   (12)

A non-transitory computer-readable medium storing a control program of a control device for causing a processor of the control device to execute a process comprising:
instructing a projection device to project a first image including a plurality of markers for adjusting a projection position,
performing a first detection process of detecting the plurality of markers based on first captured image data that is obtained by capturing a projection image of the first image, and
performing a second detection process of detecting, in a case where there is an undetected marker that is not detected in the first detection process, at least the undetected marker.

According to the present invention, it is possible to provide a control device, a control method, and a computer-readable medium capable of accurately adjusting a projection position of a projection device.

### BRIEF DESCRIPTION OF THE DRAWINGS

FIG. 1 is a diagram showing an example of a projection system 100 of an embodiment.

FIG. 2 is a diagram showing an example of a first projection device 10a and a second projection device 10b.

FIG. 3 is a schematic diagram showing an example of an internal configuration of a projection section 1.

FIG. 4 is a schematic diagram showing an exterior configuration of a projection device 10.

FIG. 5 is a schematic cross-sectional view of an optical unit 106 of the projection device 10 shown in FIG. 4.

FIG. 6 is a diagram showing an example of a hardware configuration of a computer 50.

FIG. 7 is a flowchart showing an example of control performed by a processor 51 of a computer 50.

FIG. 8 is a diagram showing an example of a first projected image 80A projected onto a projection object 6 from the first projection device 10a.

FIG. 9 is a diagram showing a red component captured image 90A obtained by capturing the first projected image 80A of FIG. 8.

FIG. 10 is a diagram showing an example of a second projected image 80B projected onto the projection object 6 from the first projection device 10a in a first recovery process.

FIG. 11 is a diagram showing a red component captured image 90B obtained by capturing the second projected image 80B of FIG. 10.

FIG. 12 is a diagram showing a recovery marker image 90C obtained by performing a subtraction process of the red component captured image 90B of FIG. 11 from the red component captured image 90A of FIG. 9.

FIG. 13 is a graph showing characteristics of spectral sensitivity of an RGB color filter.

FIG. 14 is a diagram showing an example of a captured image acquired in a second recovery process.

FIG. 15 is a diagram showing a projection position adjustment image 220 including an image of markers 81 detected in the second recovery process.

FIG. 16 is a diagram showing an example of a first projected image 310 projected onto the projection object 6 from the first projection device 10a.

FIG. 17 is a diagram showing an example of a partial captured image 320 obtained by capturing the first projected image 310 of FIG. 16.

FIG. 18 is a diagram showing an example of a marker 381 disposed to avoid a socket 321.

FIG. 19 is a diagram showing a partial captured image 330 obtained by capturing the first projected image 310 of FIG. 16.

FIG. 20 is a diagram showing an example of the marker 381 having a shape changed to avoid the socket 321.

FIG. 21 is a schematic diagram showing another exterior configuration of the projection device 10.

FIG. 22 is a schematic cross-sectional view of the optical unit 106 of the projection device 10 shown in FIG. 21.

### DESCRIPTION OF THE PREFERRED EMBODIMENTS

Hereinafter, an example of an embodiment of the present invention will be described with reference to the drawings.

### (Embodiment)

### <Projection System 100 of Embodiment>

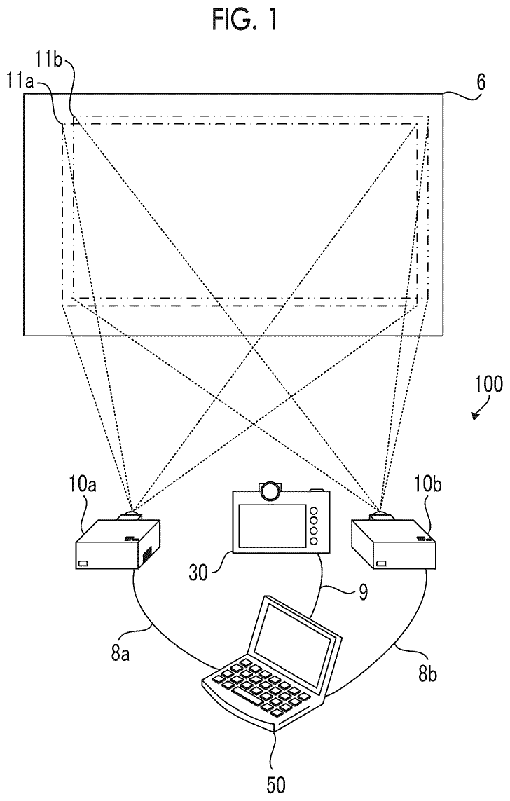

FIG. 1 is a diagram showing an example of a projection system 100 of the embodiment. As shown in FIG. 1, the projection system 100 comprises a first projection device 10a, a second projection device 10b, a computer 50, and an imaging device 30. The computer 50 is an example of a control device according to the embodiment of the present invention.

The computer 50 can communicate with the first projection device 10a, the second projection device 10b, and the imaging device 30. In the example shown in FIG. 1, the computer 50 is connected to the first projection device 10a via a communication cable 8a to be capable of communicating with the first projection device 10a. In addition, the computer 50 is connected to the second projection device 10b via a communication cable 8b to be capable of communicating with the second projection device 10b. In addition, the computer 50 is connected to the imaging device 30 via a communication cable 9 and can communicate with the imaging device 30. The first projection device 10a, the second projection device 10b, and the imaging device 30 may be configured to be integrated with the computer 50.

The first projection device 10a and the second projection device 10b are projection devices that can perform projection onto a projection object 6. The imaging device 30 is an imaging device that can capture images projected onto the projection object 6 by means of the first projection device 10a and the second projection device 10b.

The projection object 6 is an object such as a wall having a projection surface on which a projected image is displayed by the first projection device 10a. In the example shown in FIG. 1, the projection surface of the projection object 6 is a rectangular wall. The wall is, for example, a projection surface on which unevenness of a joint of a wall surface, an obstacle such as an embedded socket on the wall surface, an appearance of the wall surface, or the like may be provided, or a shadow of another object may occur. It is assumed that upper, lower, left, and right sides of the projection object 6 in FIG. 1 are upper, lower, left, and right sides of the actual projection object 6.

A projection range 11a shown by an one-dot dashed line is a region in the projection object 6 that is irradiated with projection light by the first projection device 10a. The projection range 11a is a part or an entirety of a projectable range within which the projection can be performed by the first projection device 10a. A projection range 11b shown by a two-dot dashed line is a region in the projection object 6 that is irradiated with projection light by the second projection device 10b. The projection range 11b is a part or an entirety of a projectable range within which the projection can be performed by the second projection device 10b. In the example shown in FIG. 1, the projection ranges 11a and 11b are rectangular.

<First Projection Device 10a and Second Projection Device 10b>

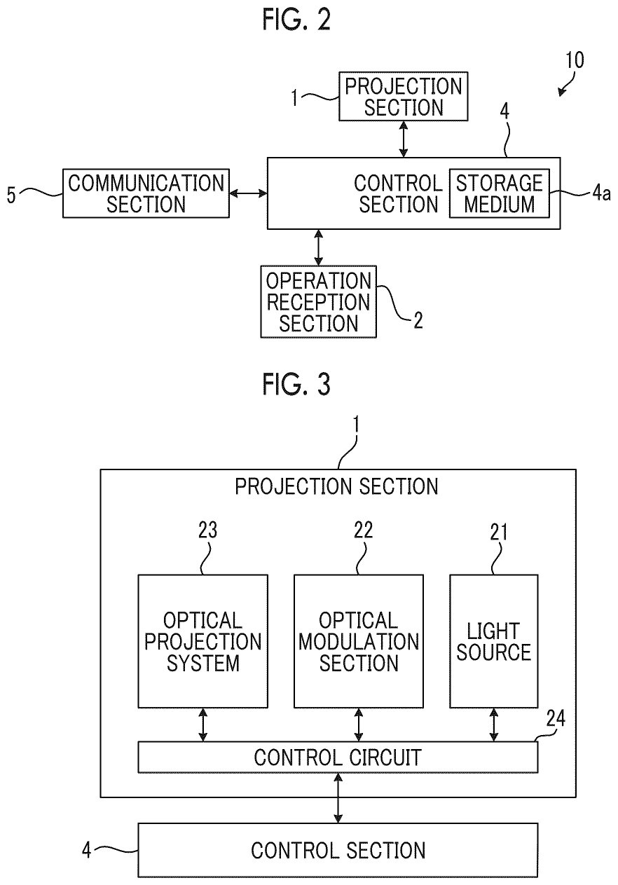

FIG. 2 is a diagram showing an example of the first projection device 10a and the second projection device 10b. Each of the first projection device 10a and the second projection device 10b is composed of, for example, a projection device 10 shown in FIG. 2. The projection device 10 comprises a projection section 1, a control section 4, an operation reception section 2, and a communication section 5. The projection section 1 is composed of, for example, a liquid crystal projector or a projector using liquid crystal on silicon (LCOS). Hereinafter, the projection section 1 will be described as a liquid crystal projector.

The control section 4 controls projection performed by the projection device 10. The control section 4 is a device including a control section composed of various processors, a communication interface (not shown) for communicating with each section, and a storage medium 4a such as a hard disk, a solid state drive (SSD), or a read-only memory (ROM) and integrally controls the projection section 1. Examples of the various processors of the control section of the control section 4 include a central processing unit (CPU) that is a general-purpose processor performing various processes by executing a program, a programmable logic device (PLD) such as a field programmable gate array (FPGA) that is a processor having a circuit configuration changeable after manufacture, or a dedicated electric circuit such as an application specific integrated circuit (ASIC) that is a processor having a circuit configuration dedicatedly designed to execute a specific process.

More specifically, a structure of these various processors is an electric circuit in which circuit elements such as semiconductor devices are combined. The control section of the control section 4 may be composed of one of the various processors or may be composed of a combination of two or more processors of the same type or different types (for example, a combination of a plurality of FPGAs or a combination of a CPU and an FPGA).

The operation reception section 2 detects an instruction from a user (user instruction) by receiving various operations from the user. The operation reception section 2 may be a button, a key, a joystick, or the like provided in the control section 4 or may be a reception unit or the like that receives a signal from a remote controller that performs a remote operation of the control section 4.

The communication section 5 is a communication interface capable of communicating with the computer 50. The communication section 5 may be a wired communication interface that performs wired communication as shown in FIG. 1, or may be a wireless communication interface that performs wireless communication.

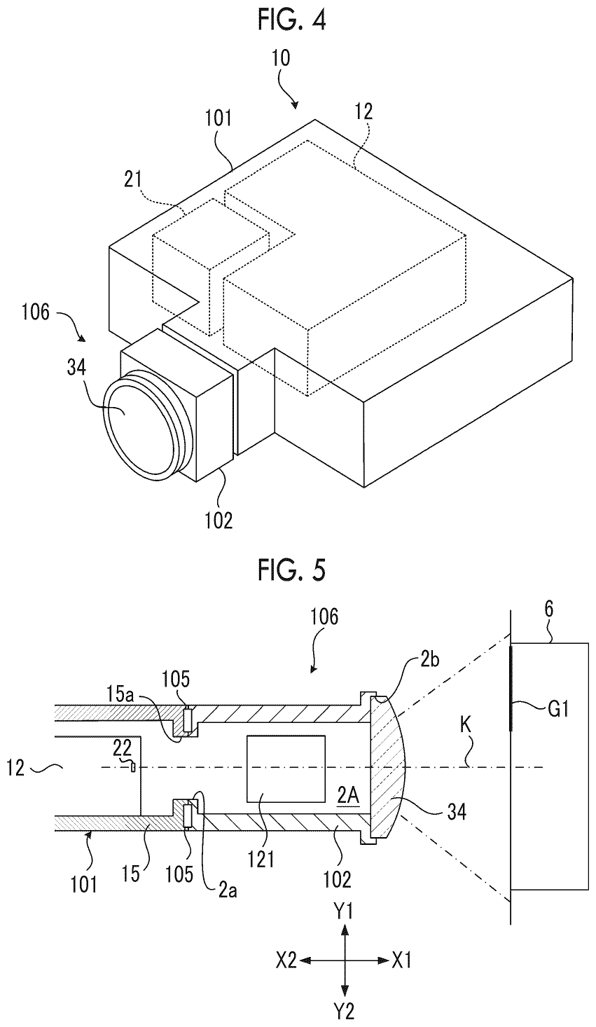

It should be noted that the projection section 1, the control section 4, and the operation reception section 2 are implemented by, for example, one device (for example, refer to FIGS. 4 and 5). Alternatively, the projection section 1, the control section 4, and the operation reception section 2 may be separate devices that cooperate by performing communication with each other.

### <Internal Configuration of Projection Section 1>

FIG. 3 is a schematic diagram showing an example of an internal configuration of the projection section 1. As shown in FIG. 3, the projection section 1 of the projection device 10 shown in FIG. 2 comprises a light source 21, an optical modulation section 22, an optical projection system 23, and a control circuit 24. The light source 21 includes a light emitting element such as a laser or a light emitting diode (LED) and emits, for example, white light.

The optical modulation section 22 is composed of three liquid crystal panels (optical modulation elements) that emit respective color images by modulating, based on image information, light of respective colors which is emitted from the light source 21 and separated into three colors, that is, red, blue, and green, by a color separation mechanism (not shown), and a dichroic prism that mixes color images emitted from the three liquid crystal panels and that emits the mixed color image in the same direction. The color images may be emitted by respectively mounting filters of red, blue, and green in the three liquid crystal panels and modulating the white light emitted from the light source 21 via respective liquid crystal panels.

The light from the light source 21 and the optical modulation section 22 is incident on the optical projection system 23. The optical projection system 23 is composed of, for example, a relay optical system including at least one lens. The light that has passed through the optical projection system 23 is projected onto the projection object 6.

In the projection object 6, a region irradiated with the light transmitted through an entire range of the optical modulation section 22 is a projectable range within which the projection can be performed by the projection section 1. In the projectable range, a region that is irradiated with the light actually transmitted through the optical modulation section 22 is a projection range of the projection section 1 (the projection range 11a or the projection range 11b). For example, in the projectable range, a size, a position, and a shape of the projection range of the projection section 1 are changed by controlling a size, a position, and a shape of a region through which the light is transmitted in the optical modulation section 22.

By controlling the light source 21, the optical modulation section 22, and the optical projection system 23 based on display data input from the control section 4, the control circuit 24 projects an image based on the display data onto the projection object 6. The display data input into the control circuit 24 is composed of three pieces of data including red display data, blue display data, and green display data.

In addition, the control circuit 24 enlarges or reduces the projection range of the projection section 1 by changing the optical projection system 23 based on a command input from the control section 4. In addition, the control section 4 may move the projection range of the projection section 1 by changing the optical projection system 23 based on an operation received from the user by the operation reception section 2.

In addition, the projection device 10 comprises a shift mechanism that mechanically or optically moves the projection range of the projection section 1 while maintaining an image circle of the optical projection system 23. The image circle of the optical projection system 23 is a region in which the projection light incident on the optical projection system 23 appropriately passes through the optical projection system 23 in terms of light fall-off, color separation, edge part curvature, and the like.

The shift mechanism is implemented by at least any one of an optical system shift mechanism that performs optical system shifting, or an electronic shift mechanism that performs electronic shifting.

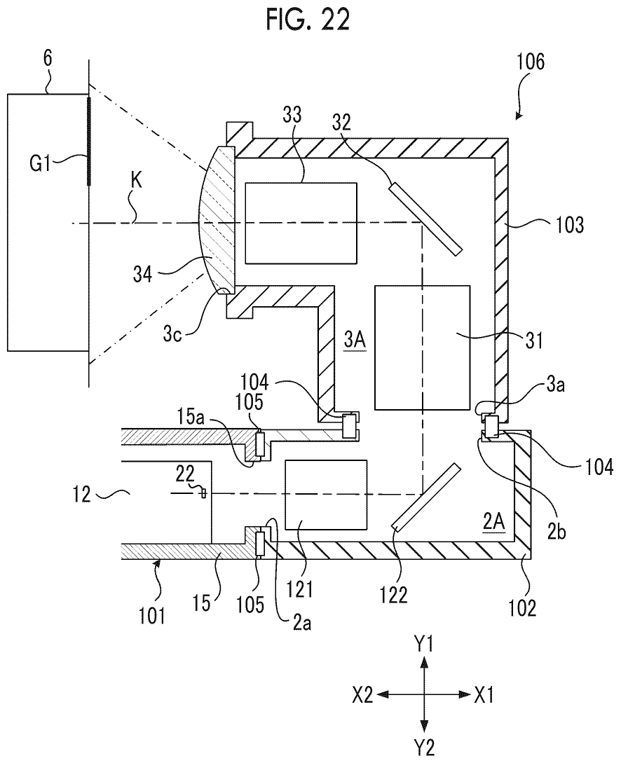

The optical system shift mechanism is, for example, a mechanism that moves the optical projection system 23 in a direction perpendicular to an optical axis (for example, refer to FIGS. 5 and 22), or a mechanism that moves the optical modulation section 22 in the direction perpendicular to the optical axis instead of moving the optical projection system 23. In addition, the optical system shift mechanism may perform the movement of the optical projection system 23 and the movement of the optical modulation section 22 in combination with each other.

The electronic shift mechanism is a mechanism that performs pseudo shifting of the projection range by changing a range through which the light is transmitted in the optical modulation section 22.

In addition, the projection device 10 may comprise a projection direction changing mechanism that moves the image circle of the optical projection system 23 and the projection range. The projection direction changing mechanism is a mechanism that changes a projection direction of the projection section 1 by changing an orientation of the projection section 1 via mechanical rotation (for example, refer to FIG. 22).

### <Mechanical Configuration of Projection Device 10>

FIG. 4 is a schematic diagram showing an exterior configuration of the projection device 10. FIG. 5 is a schematic cross-sectional view of an optical unit 106 of the projection device 10 shown in FIG. 4. FIG. 5 shows a cross section in a plane along an optical path of light emitted from a body part 101 shown in FIG. 4.

As shown in FIG. 4, the projection device 10 comprises the body part 101 and the optical unit 106 that is provided to protrude from the body part 101. In the configuration shown in FIG. 4, the operation reception section 2; the control section 4; the light source 21, the optical modulation section 22, and the control circuit 24 in the projection section 1; and the communication section 5 are provided in the body part 101. The optical projection system 23 in the projection section 1 is provided in the optical unit 106.

The optical unit 106 comprises a first member 102 supported by the body part 101. The optical unit 106 may be configured to be attachable to and detachable from the body part 101 (in other words, configured to be interchangeable).

As shown in FIG. 5, the body part 101 includes a housing 15 in which an opening 15a for passing light is formed in a part connected to the optical unit 106.

As shown in FIG. 4, the light source 21 and an optical modulation unit 12 including the optical modulation section 22 (refer to FIG. 3) that generates an image by spatially modulating the light emitted from the light source 21 based on input image data are provided inside the housing 15 of the body part 101. The light emitted from the light source 21 is incident on the optical modulation section 22 of the optical modulation unit 12 and is spatially modulated and emitted by the optical modulation section 22.

As shown in FIG. 5, the image formed by the light spatially modulated by the optical modulation unit 12 is incident on the optical unit 106 by passing through the opening 15a of the housing 15 and is projected onto the projection object 6. Accordingly, an image G1 is visible to an observer.

As shown in FIG. 5, the optical unit 106 comprises the first member 102 having a hollow portion 2A connected to an inside of the body part 101, a first optical system 121 disposed in the hollow portion 2A, a lens 34, and a first shift mechanism 105.

The first member 102 is a member having, for example, a rectangular cross-sectional exterior, in which an opening 2a and an opening 2b are formed on surfaces parallel to each other. The first member 102 is supported by the body part 101 in a state where the opening 2a is disposed at a position facing the opening 15a of the body part 101. The light emitted from the optical modulation section 22 of the optical modulation unit 12 of the body part 101 is incident into the hollow portion 2A of the first member 102 through the opening 15a and the opening 2a.

An incidence direction of the light incident into the hollow portion 2A from the body part 101 will be referred to as a direction X1. A direction opposite to the direction X1 will be referred to as a direction X2. The direction X1 and the direction X2 will be collectively referred to as a direction X. In addition, a direction from the front to the back of the page of FIG. 5 and its opposite direction will be referred to as a direction Z. In the direction Z, the direction from the front to the back of the page will be referred to as a direction Z1, and the direction from the back to the front of the page will be referred to as a direction Z2.

In addition, a direction perpendicular to the direction X and to the direction Z will be referred to as a direction Y. In the direction Y, an upward direction in FIG. 5 will be referred to as a direction Y1, and a downward direction in FIG. 5 will be referred to as a direction Y2. In the example in FIG. 5, the projection device 10 is disposed such that the direction Y2 is a vertical direction.

The optical projection system 23 shown in FIG. 3 is composed of the first optical system 121 and the lens 34 in the example in FIG. 5. An optical axis K of this optical projection system 23 is shown in FIG. 5. The first optical system 121 and the lens 34 are disposed in this order from an optical modulation section 22 side along the optical axis K.

The first optical system 121 includes at least one lens and guides, to the lens 34, the light that is incident on the first member 102 from the body part 101 and that travels in the direction X1.

The lens 34 closes the opening 2b formed in an end part of the first member 102 on a direction X1 side and is disposed in the end part. The lens 34 projects the light incident from the first optical system 121 onto the projection object 6.

The first shift mechanism 105 is a mechanism for moving the optical axis K of the optical projection system (in other words, the optical unit 106) in a direction perpendicular to the optical axis K (the direction Y in FIG. 5). Specifically, the first shift mechanism 105 is configured to change a position of the first member 102 in the direction Y with respect to the body part 101. The first shift mechanism 105 may manually move the first member 102 or electrically move the first member 102.

FIG. 5 shows a state where the first member 102 is moved as far as possible to a direction Y1 side by the first shift mechanism 105. By moving the first member 102 in the direction Y2 by means of the first shift mechanism 105 from the state shown in FIG. 5, a relative position between a center of the image (in other words, a center of a display surface) formed by the optical modulation section 22 and the optical axis K changes, and the image G1 projected onto the projection object 6 can be shifted (translated) in the direction Y2.

The first shift mechanism 105 may be a mechanism that moves the optical modulation section 22 in the direction Y instead of moving the optical unit 106 in the direction Y. Even in this case, the image G1 projected onto the projection object 6 can be moved in the direction Y.

### <Hardware Configuration of Computer 50>

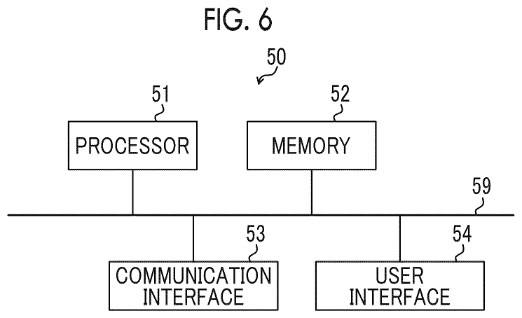

FIG. 6 is a diagram showing an example of a hardware configuration of the computer 50. As shown in FIG. 6, the computer 50 shown in FIG. 1 comprises a processor 51, a memory 52, a communication interface 53, and a user interface 54. The processor 51, the memory 52, the communication interface 53, and the user interface 54 are connected by, for example, a bus 59.

The processor 51 is a circuit that processes signals, and is, for example, a CPU that controls the entire computer 50. The processor 51 may be implemented by other digital circuits such as an FPGA and a digital signal processor (DSP). In addition, the processor 51 may be implemented by combining a plurality of digital circuits.

The memory 52 includes, for example, a main memory and an auxiliary memory. The main memory is, for example, a random-access memory (RAM). The main memory is used as a work area of the processor 51.

The auxiliary memory is, for example, a non-volatile memory such as a magnetic disk, an optical disc, or a flash memory. Various programs for operating the computer 50 are stored in the auxiliary memory. The programs stored in the auxiliary memory are loaded into the main memory and executed by the processor 51.

In addition, the auxiliary memory may include a portable memory that can be attached to and detached from the computer 50. Examples of the portable memory include a universal serial bus (USB) flash drive, a memory card such as a secure digital (SD) memory card, and an external hard disk drive.

The communication interface 53 is a communication interface that communicates with an external device of the computer 50 (for example, the first projection device 10a, the second projection device 10b, and the imaging device 30). The communication interface 53 is controlled by the processor 51. The communication interface 53 may be a wired communication interface that performs wired communication or a wireless communication interface that performs wireless communication, or may include both of the wired communication interface and the wireless communication interface.

The user interface 54 includes, for example, an input device that receives operation input from a user, and an output device that outputs information to the user. The input device can be implemented by, for example, a pointing device (for example, a mouse), a key (for example, a keyboard), or a remote controller. The output device can be implemented by, for example, a display or a speaker. In addition, the input device and the output device may be implemented by a touch panel or the like. The user interface 54 is controlled by the processor 51.

### <Control Performed by Computer 50>

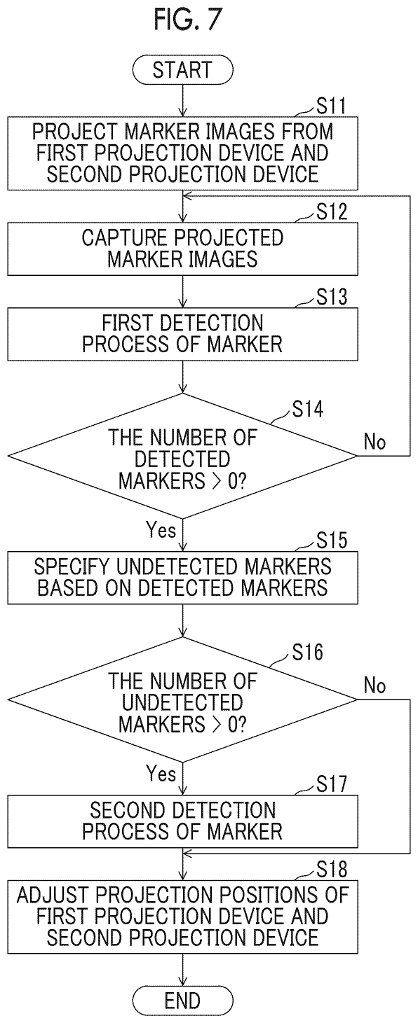

FIG. 7 is a flowchart showing an example of control performed by the processor 51 of the computer 50. For example, as shown in FIG. 7, the computer 50 executes a process of adjusting projection positions of the first projection device 10a and the second projection device 10b. A plurality of marker images to be projected by the first projection device 10a and the second projection device 10b are prepared in advance. The plurality of marker images are images for adjusting the projection position of the first projection device 10a and the projection position of the second projection device 10b. A color of the marker image projected by the first projection device 10a and a color of the marker image projected by the second projection device 10b are different from each other. The color of the marker image projected by the first projection device 10a is, for example, red. The color of the marker image projected by the second projection device 10b is, for example, blue. The color of the marker image projected by the first projection device 10a may be blue, and the color of the marker image projected by the second projection device 10b may be red. The plurality of marker images projected by the first projection device 10a are markers that all differ in shape and can be uniquely specified. The plurality of marker images projected by the second projection device 10b are markers that all differ in shape and can be uniquely specified. The plurality of marker images projected by the first projection device 10a and the plurality of marker images projected by the second projection device 10b are marker images that have the colors different from each other and have the same disposition and the same shapes as the corresponding markers.

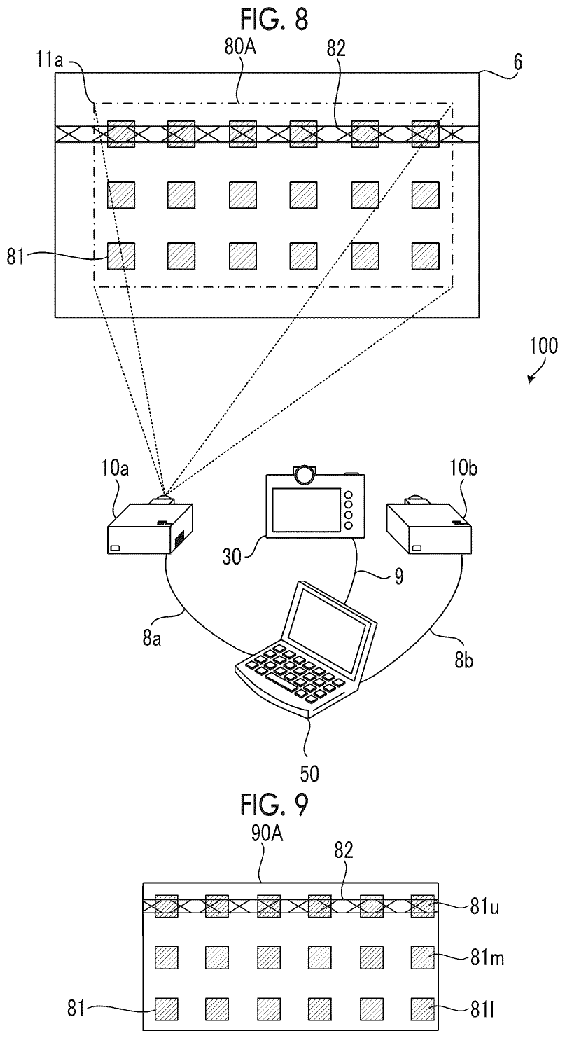

First, the computer 50 performs control of communicating with the first projection device 10a and the second projection device 10b, causing the first projection device 10a to project the plurality of marker images, which are targets, onto the projection object 6, and causing the second projection device 10b to project the plurality of marker images, which are targets, onto the projection object 6 (step S11). Projection of the marker images performed by the first projection device 10a and the second projection device 10b will be described later (for example, refer to FIG. 8)

Next, the computer 50 performs control of capturing the marker images projected in step S11 by means of the imaging device 30 (step S12). The capturing of the marker images using the imaging device 30 may be performed by transmitting an imaging instruction signal to the imaging device 30 to cause the imaging device 30 to perform the imaging, or may be performed by the user by issuing an imaging instruction to the user. The computer 50 receives captured image data of the image obtained by the capturing in step S12 from the imaging device 30.

Next, the computer 50 executes a first detection process of detecting markers in the marker image projected from the first projection device 10a and the marker image projected from the second projection device 10b based on the captured image data obtained by capturing the projected image in step S12 (step S13).

Next, the computer 50 determines whether or not the number of detected markers detected in the first detection process in step S13 is greater than 0, that is, whether or not the marker can be detected (step S14).

In step S14, in a case where the marker cannot be detected (step S14: No), the computer 50 returns to step S12 and performs each process again. In this case, a marker imaging condition for capturing the marker image may be changed (for example, a search range may be changed).

In step S14, in a case where the marker can be detected (step S14: Yes), the computer 50 specifies the undetected marker that cannot be detected in the first detection process based on the detected marker detected in the first detection process in step S13 (step S15). The computer 50 specifies the presence or absence of the undetected marker based on, for example, the number of the marker images projected in step S11 and the number of marker images that can be detected in step S13.

Next, the computer 50 determines whether or not the number of undetected markers that can be specified in step S15 is greater than 0, that is, whether or not there is the undetected marker (step S16).

In step S16, in a case where there is the undetected marker (step S16: Yes), the computer 50 executes a second detection process of detecting the undetected marker (step S17). The computer 50 detects the undetected marker in each of the marker images projected from the first projection device 10a and the marker images projected from the second projection device 10b in step S11. The second detection process of detecting the undetected marker will be described later (for example, FIGS. 8, 13, 16, and 18). In a detection process described below, the second detection process is referred to as “a recovery process of marker detection”.

Next, the computer 50 performs control of adjusting a relative projection position between the first projection device 10a and the second projection device 10b based on the detected marker including the marker detected in the second detection process in step S17 (step S18), and ends the series of processes.

Meanwhile, in a case where there is no undetected marker in step S16 (step S16: No), the computer 50 proceeds to step S18 without further action and performs control of adjusting the projection position.

The adjustment of the projection position in the present example is adjustment in a case of performing stack projection for improving a dynamic range and gradation representation by superimposing the entire projection range 11a of the first projection device 10a and the entire projection range 11b of the second projection device 10b and projecting the same image from the first projection device 10a and the second projection device 10b. The computer 50 specifies a current relative position between the projection range 11a of the first projection device 10a and the projection range 11b of the second projection device 10b based on the positions of the detected red and blue markers. The computer 50 adjusts the relative projection position between the first projection device 10a and the second projection device 10b based on the current relative position between the projection range 11a and the projection range 11b which are specified such that the entire projection range 11a and the entire projection range 11b are superimposed on each other. This adjustment can be performed by, for example, controlling the shift mechanism of at least any one of the first projection device 10a or the second projection device 10b (the optical system shift mechanism or the electronic shift mechanism). For example, in FIG. 1, by controlling the shift mechanism of the second projection device 10b to adjust the projection range 11b with reference to the projection range 11a of the first projection device 10a, the computer 50 enables the stack projection by superimposing the entire projection range 11a and the entire projection range 11b on each other.

In a case where the marker that cannot be detected even after the second detection process in step S17 is performed still remains (in a case where some markers cannot be detected), the adjustment of the projection position may be performed in step S18 only with the markers that can be detected, or the second detection process may be performed again by changing a detection method.

In addition, in the above-described example, the two projection devices (the first projection device 10a and the second projection device 10b) are simultaneously registered, but for example, the first projection device 10a or the second projection device 10b may be registered one by one.

### <First Recovery Process of Marker Detection>

A first recovery process for detecting the marker image projected onto the projection object 6 will be described with reference to FIGS. 8 to 12. The first recovery process is an example of the second detection process in step S17 of FIG. 7.

Here, first, a situation until the execution of the first recovery process is started, that is, steps S11 to S16 in FIG. 7 will be described with reference to FIGS. 8 and 9. FIG. 8 is a diagram showing an example of a first projected image 80A projected onto the projection object 6 from the first projection device 10a. This corresponds to the marker image projected in step S11 of FIG. 7. However, for the sake of clarity of the drawing, a case where the marker image is projected only from the first projection device 10a will be described as shown in FIG. 8.

The computer 50 performs control of causing the first projection device 10a to project the first projected image 80A onto the projection object 6. The first projected image 80A is an example of a “first image” in the present invention. The first projected image 80A includes images of a plurality of markers 81 for adjusting the projection position of the first projection device 10a. The first projected image 80A shown in FIG. 8 includes images of 3×6=18 markers 81 arranged in a lattice form. The marker 81 is a red marker. Markers 81 of the present example are displayed as uniform rectangular markers, but in actuality, markers 81 are markers that all differ in shape and can be uniquely specified.

In addition, in the case of the present example, in the projection object 6 onto which the first projected image 80A is projected, in addition to the first projected image 80A, a shadow 82 generated by lighting from a lighting device installed in the vicinity is reflected. The shadow 82 of the present example is a shadow of a steel frame member present in the periphery, and is reflected as a pattern of the background of the first projected image 80A. The shadow 82 of the steel frame member in the present example is, for example, a gray (ash-colored) shadow. The shadow 82 is reflected to overlap with six markers 81 arranged in an upper row in a horizontal direction among the eighteen markers 81.

FIG. 9 is a diagram showing a red component captured image 90A obtained by capturing the first projected image 80A of FIG. 8 projected onto the projection object 6. This corresponds to a captured image including the marker images captured in step S12 of FIG. 7. The computer 50 performs control of causing the imaging device 30 to capture the first projected image 80A. As shown in FIG. 9, the red markers 81 and the shadow 82 of the steel frame member are imaged in the red component captured image 90A.

The computer 50 performs the first detection process for detecting a plurality of (eighteen) markers based on captured image data of a first red component obtained from the red component captured image 90A. This corresponds to the first detection process in step S13 of FIG. 7. The captured image data of the first red component is an example of “first captured image data” in the present invention.

Meanwhile, since the shadow 82 of the steel frame member overlaps with and is reflected on the six markers arranged in the upper row in the horizontal direction as described above in the first projected image 80A, the computer 50 cannot detect the six markers and fails in the detection in the first detection process.

Therefore, in the case of the red component captured image 90A shown in FIG. 9, the computer 50 can detect the six middle stage markers 81m arranged in a middle stage in the horizontal direction and the six lower stage markers 81l arranged in a lower stage in the horizontal direction through the first detection process, but cannot detect the six upper stage markers 81u arranged in an upper stage in the horizontal direction.

The computer 50 determines the presence or absence of the undetected marker based on the number of the marker images projected in FIG. 8 and the number of marker images detected in FIG. 9. This corresponds to the processes in steps S15 and S16 of FIG. 7. Then, the computer 50 starts the first recovery process in a case where it is determined that there is the undetected marker.

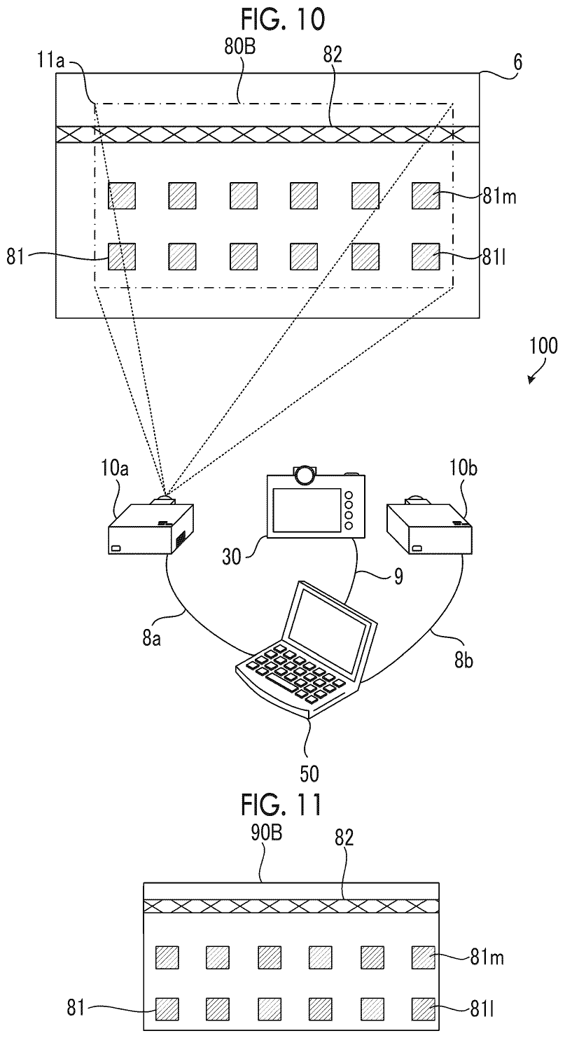

FIG. 10 is a diagram showing an example of a second projected image 80B projected onto the projection object 6 from the first projection device 10a in the first recovery process. The computer 50 performs control of causing the first projection device 10a to project the second projected image 80B onto the projection object 6. The second projected image 80B is an example of a “second image” in the present invention. The second projected image 80B is a marker image for adjusting the projection position of the first projection device 10a, and includes the images of the markers 81 obtained by excluding the (six) images of the undetected markers 81 determined in FIG. 9 from the (eighteen) images of the markers 81 projected in FIG. 8. That is, the computer 50 causes the second projected image 80B including only the (twelve) images of the markers 81 that can be detected in the first detection process to be projected.

As shown in FIG. 10, in the projection object 6 onto which the second projected image 80B is projected, in addition to the second projected image 80B, a shadow 82 of the steel frame member is reflected. The shadow 82 is reflected at the same position as the position of the shadow 82 reflected in FIG. 8.

FIG. 11 is a diagram showing a red component captured image 90B obtained by capturing the second projected image 80B of FIG. 10 projected onto the projection object 6. The computer 50 performs control of causing the imaging device 30 to capture the second projected image 80B. As shown in FIG. 11, the red marker 81 and the shadow 82 of the steel frame member are imaged in the red component captured image 90B obtained by capturing.

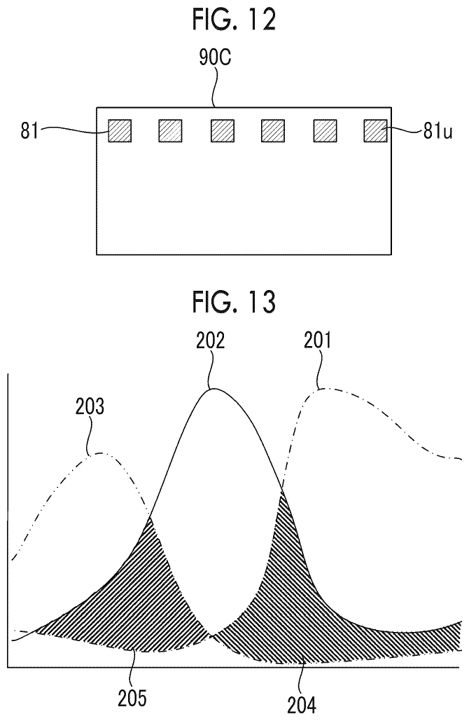

FIG. 12 is a diagram showing a recovery marker image 90C obtained by performing a subtraction process of the red component captured image 90B of FIG. 11 from the red component captured image 90A of FIG. 9. The computer 50 performs the detection process of the undetected marker based on the subtraction process between the captured image data of the first red component obtained from the red component captured image 90A and the captured image data of a second red component obtained from the red component captured image 90B. The computer 50 acquires image data obtained by reducing information other than the undetected marker (detected marker and background) from the captured image data of the first red component through the subtraction process, and performs the detection process of the undetected marker based on the image data. An image generated from the image data acquired by the subtraction process is the recovery marker image 90C. By performing the subtraction process of the red component captured image 90B of FIG. 11 from the red component captured image 90A of FIG. 9, the pattern or the like of the background including the shadow 82 that inhibits the detection of the upper stage markers 81u is removed, and the upper stage markers 81u can be detected. The captured image data of the second red component is an example of “second captured image data” in the present invention.

The computer 50 adjusts the projection position of the first projection device 10a by using all the markers 81 including the upper stage marker 81u that can be detected in the first recovery process, and the middle stage marker 81m and the lower stage marker 81l that are detected in the first detection process.

In FIGS. 8 to 12, the first projected image 80A projected from the first projection device 10a has been described. However, the first recovery process is also executed for the projected image projected from the second projection device 10b.

By the way, in the stack projection in which the brightness is increased by overlapping the projections with each other, registration work between the projections is complicated and not easy, and it takes time and effort. For example, in the registration in a temporary event such as an installation in an exhibition with a time constraint in which the installation time is limited, issues often arise, such as the projection surface being irradiated with work lighting, or the projection surface itself being uneven. In such a situation, for example, it is not possible to detect a registration pattern from the image projected onto the projection surface in order to perform the registration work, and the registration work is complicated and requires time and effort.

On the other hand, in the first recovery process, the computer 50 of the present embodiment performs the detection process of the undetected marker based on the subtraction process between the captured image data of the red component captured image 90A obtained by capturing the first projected image 80A and the captured image data of the red component captured image 90B obtained by capturing the second projected image 80B. According to this configuration, it is possible to remove the pattern or the like of the background including the shadow 82 of the steel frame member that inhibits the detection of the markers 81 from the data of the captured image, and it is possible to detect the detection-failed marker 81 that cannot be detected in the first detection process. Accordingly, the position of the projection range 11a of the first projection device 10a and the position of the projection range 11b of the second projection device 10b can be accurately adjusted by using more markers 81 for adjusting the projection position. Therefore, even in a case where the projection device is installed at a place where a surrounding environment may be disturbed, it is possible to easily perform the registration between the projections, and efficiency of the registration work can be significantly improved.

### <Second Recovery Process of Marker Detection>

The second recovery process for detecting the marker image projected onto the projection object 6 will be described with reference to FIGS. 13 to 15. The second recovery process is an example of the second detection process in step S17 of FIG. 7. Since a situation until the execution of the second recovery process is started (steps S11 to S16 in FIG. 7) is the same as the content described in FIGS. 8 and 9 for the first recovery process, the description thereof will be omitted here.

FIG. 13 is a graph showing characteristics of spectral sensitivity of the RGB color filter. A horizontal axis represents a wavelength, and a vertical axis represents the relative sensitivity. As shown in FIG. 13, an R (red) component 201, a G (green) component 202, and a B (blue) component 203 have different sensitivity characteristics, but for example, a wavelength range 204 of parts of the R component 201 and the G component 202, or a wavelength range 205 of parts of the G component 202 and the B component 203 has overlapping sensitivity characteristics.

As described above, the color of the marker used for adjusting the projection position of the first projection device 10a is a red marker. The red color is an example of “a first color corresponding to a first wavelength range” in the present invention. As the second recovery process, the computer 50 performs the detection process of the undetected marker based on red image data consisting of only the red component in the captured image data of the first red component obtained from the red component captured image 90A and green image data consisting of only a green component in the captured image data of the first red component. The red image data is an example of “first color image data” in the present invention. The green color is an example of “a second color corresponding to a second wavelength range” in the present invention. The green wavelength range is a wavelength range that partially overlaps with the red wavelength range. The green image data is an example of “second color image data” in the present invention.

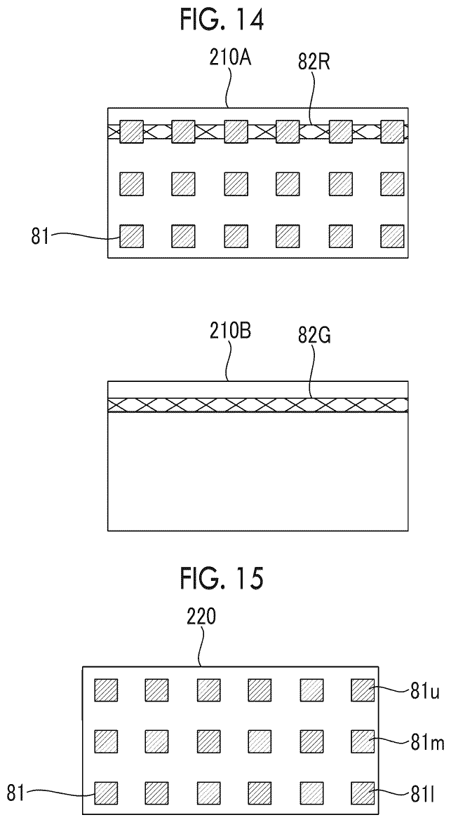

FIG. 14 is a diagram showing an example of the captured image acquired in the second recovery process. The upper diagram in FIG. 14 is a red-extracted captured image 210A in which only the red component is extracted from the red component captured image 90A (refer to FIG. 9) obtained by capturing the first projected image 80A of FIG. 8. The computer 50 performs control of causing the imaging device 30 to capture the first projected image 80A and extracting the red image data consisting of only the red component based on the captured image data of the first red component obtained from the red component captured image 90A that is captured. The computer 50 generates the red-extracted captured image 210A from the red image data consisting of only the extracted red component. As shown in the upper diagram in FIG. 14, in the red-extracted captured image 210A, the red marker 81 and a red shadow 82R consisting of a red component of the shadow 82 of the steel frame member are imaged. In the present example, the shadow 82 of the steel frame member that is reflected together with the first projected image 80A in FIG. 8 is a gray (ash-colored) shadow.

The lower diagram in FIG. 14 is a green-extracted captured image 210B obtained by extracting only the green component from the red component captured image 90A (refer to FIG. 9) obtained by capturing the first projected image 80A of FIG. 8. The computer 50 performs control of causing the imaging device 30 to capture the first projected image 80A and extracting the green image data consisting of only the green component based on the captured image data of the first red component obtained from the red component captured image 90A that is captured. The computer 50 generates the green-extracted captured image 210B from the green image data consisting of only the extracted green component. As shown in the lower diagram in FIG. 14, in the green-extracted captured image 210B, a green shadow 82G consisting of a green component of the shadow 82 of the steel frame member are imaged.

FIG. 15 is a diagram showing a projection position adjustment image 220 including the image of markers 81 detected in the second recovery process. The computer 50 performs the detection process of the undetected marker based on the subtraction process between the red image data obtained from the red-extracted captured image 210A and the green image data obtained from the green-extracted captured image 210B. The computer 50 performs a subtraction process of subtracting brightness of the red image data (a pixel value of the red component) and brightness of the green image data (a pixel value of the green component) for each pixel.

The computer 50 can acquire processed red image data in which information other than the marker (background) is reduced from the red image data through the subtraction process. The computer 50 performs the detection process of the marker again based on the processed red image data. The marker detected based on the processed red image data is the marker shown in the projection position adjustment image 220 of FIG. 15. In the projection position adjustment image 220, it is possible to check the eighteen red markers 81 including the upper stage markers 81u that can be detected in the above-described detection process performed again, in addition to the middle stage markers 81m and the lower stage markers 81l. By performing the subtraction process in this way, it is possible to reduce the pattern or the like of the background including the shadow 82 that inhibits the detection of the upper stage markers 81u, and it is possible to detect the upper stage markers 81u.

The computer 50 adjusts the projection position of the first projection device 10a by using all the markers 81 including the upper stage markers 81u that can be detected in the second recovery process and the middle stage marker 81m and the lower stage marker 81l that are detected in the first detection process. In FIGS. 13 to 15, the first projected image 80A projected from the first projection device 10a has been described. However, the second recovery process is also executed for the projected image projected from the second projection device 10b. In that case, the marker used for adjusting the projection position of the second projection device 10b is a blue marker, and the blue color is an example of “a first color corresponding to a first wavelength range” in the present invention.

As described above, in the second recovery process, the computer 50 performs the detection process of the undetected marker based on the subtraction process between the red image data obtained from the red-extracted captured image 210A and the green image data obtained from the green-extracted captured image 210B. According to this configuration, it is possible to acquire the processed red image data in which the information, such as the pattern or the like of the background including the shadow 82 of the steel frame member that inhibits the detection of the markers 81, is reduced from the red image data through the subtraction process. Then, the markers 81 including the detection-failed marker 81 that cannot be detected in the first detection process can be detected through the detection process based on the processed red image data. As a result, as in the case of the first recovery process, the projection position can be accurately adjusted by using more markers 81 for adjusting the projection position, and the efficiency of the registration work can be significantly improved.

In the above description, the second recovery process is executed as the second detection process in step S17 of FIG. 7. However, for example, this recovery process may be executed as the first detection process in step S13 of FIG. 7.

### <Modification Example of Second Recovery Process>

In the second recovery process, in the subtraction process of reducing information other than the marker (background) from the red image data, the process of simply subtracting the green image data from the red image data is performed. However, for example, the following process may be performed according to the type of information to be subtracted (background).

In the second recovery process, the shadow 82 of the steel frame member that is reflected together with the first projected image 80A is described as a gray (ash-colored) shadow. Since the shadow 82 is gray, the image data includes substantially the same brightness of the red component and the brightness of the green component. Therefore, in this case, the component of the shadow 82 of the steel frame member is reduced by simply performing the subtraction process of the green image data from the red image data. However, the background that is reflected may be of a type other than gray, and in this case, a difference may occur between the brightness of the red component and the brightness of the green component included in the image data. Therefore, for example, a brightness level (gray level) of the green component is adjusted and standardized to match a brightness level of the red component, and then the subtraction process is performed. Specifically, an offset value is added to the green component such that the most frequent pixel value in the red component and the most frequent pixel value in the green component match each other from a pixel value histogram of each component.

The computer 50 calculates a coefficient based on the red image data and the green image data in order to match the most frequent pixel values in the red component and the green component. The computer 50 performs the detection process of the undetected marker based on the subtraction process between the red image data and the green image data that is corrected by the coefficient.

As described above, with the computer 50 of the modification example, the brightness level (gray level) of the green component can be corrected according to the type of the background (pattern) that is reflected together with the first projected image 80A. Therefore, it is possible to reliably reduce the information other than the marker (background) from the red image data regardless of the type of the background, and it is possible to detect the detection-failed marker 81 that cannot be detected in the first detection process.

### <Third Recovery Process of Marker Detection>

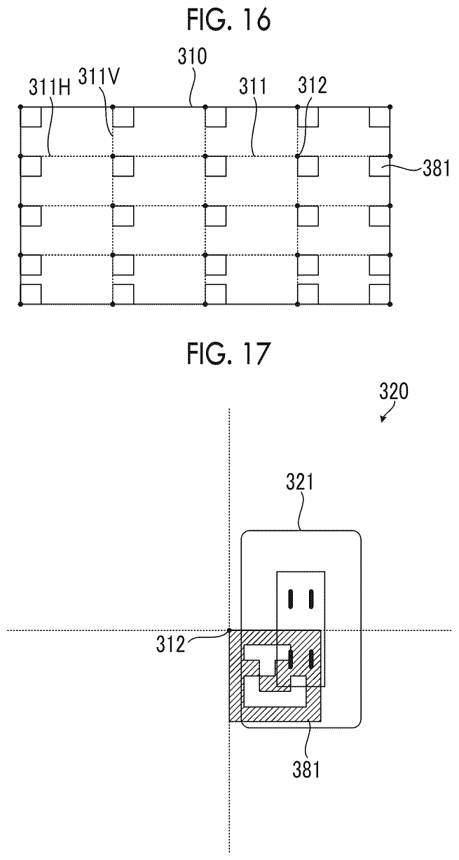

A third recovery process for detecting the marker image projected onto the projection object 6 will be described with reference to FIGS. 16 to 18. The third recovery process is an example of the second detection process in step S17 of FIG. 7. Since a situation until the execution of the third recovery process is started (steps 11 to S16 in FIG. 7) is the same as the content described in FIGS. 8 and 9 for the first recovery process, the description thereof will be omitted here.

FIG. 16 is a diagram showing an example of a first projected image 310 projected onto the projection object 6 from the first projection device 10a. The first projected image 310 is an example of “a third image” in the present invention. As shown in FIG. 16, the first projected image 310 includes a grid lattice 311 for adjusting the projection position of the first projection device 10a and an image of markers 381. The first projected image 310 is an image including markers 381 in which at least any one of a position, an orientation, or a shape is different from a position, an orientation, or a shape of the plurality of markers 81 in the first projected image 80A.

The grid lattice 311 has a horizontal grid 311H that is a horizontal reference and a vertical grid 311V that is a vertical reference. The marker 381 is disposed with a point at which the horizontal grid 311H and the vertical grid 311V intersect each other (hereinafter, referred to as a “reference point”) as a reference. Each marker 381 is disposed such that one point at a marker corner coincides with the reference point 312. Markers 381 of the present example are displayed as uniform rectangular markers, but in actuality, markers 381 are markers that all differ in shape and can be uniquely specified.

The computer 50 performs control of causing the first projection device 10a to project the first projected image 310 onto the projection object 6 as the third recovery process. The arrangement of the markers 381 shown in this example is different from the arrangement of the markers 81 shown in the first projected image 80A of FIG. 8. However, the present invention is not limited thereto, and for example, the markers 381 may have the same arrangement as the markers 81 arranged in a 3×6 grid in the first projected image 80A of FIG. 8.

FIG. 17 is a diagram showing an example of a partial captured image 320 obtained by capturing the first projected image 310 of FIG. 16 projected onto the projection object 6. The computer 50 performs control of causing the imaging device 30 to capture the first projected image 310. The computer 50 specifies the reference point 312 corresponding to the marker 381 for which the detection has failed in the captured image acquired by the capturing of the first projected image 310. The computer 50 acquires a partial image of a region centered on the specified reference point 312. The partial captured image 320 shown in FIG. 17 is a diagram showing an example of the partial image of the region centered on the reference point 312 corresponding to the marker 381 for which the detection has failed. The computer 50 performs the detection process of the undetected marker based on partial captured image data obtained from the partial captured image 320. The partial captured image data is an example of “third captured image data” in the present invention.

As shown in FIG. 17, an embedded socket 321 is provided, for example, on a wall surface, which is the projection object 6, around the reference point 312 in the partial captured image 320. On the other hand, the marker 381 disposed to match one point of the marker corner with the reference point 312 is displayed at a position overlapping with the socket 321 on the wall surface. Therefore, the computer 50 cannot distinguish between an appearance of the socket 321 and the image of the markers 381, and cannot detect the markers 381. The marker 381 in the present example is disposed such that an upper left marker corner point matches the reference point 312.

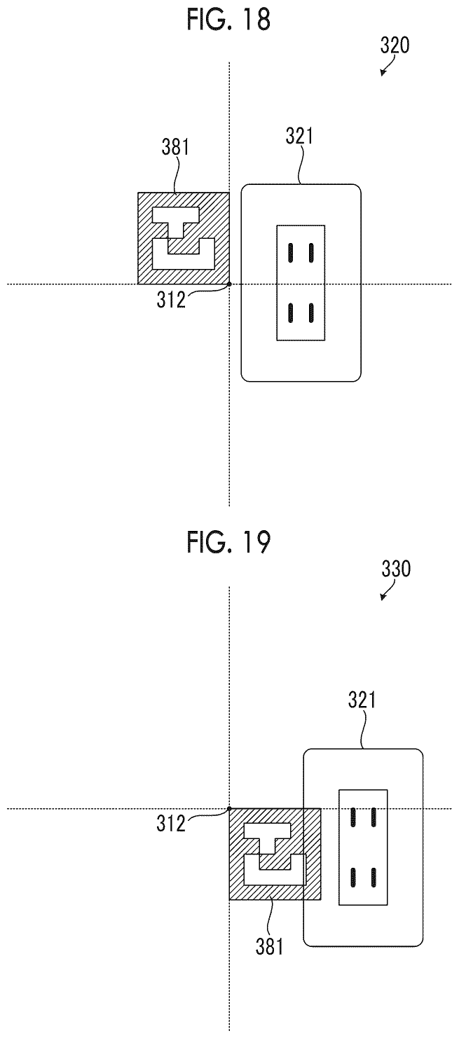

FIG. 18 is a diagram showing an example of the marker 381 disposed to avoid the socket 321. The computer 50 performs control of performing movement, rotation, or the like on the marker 381 disposed to match one point of the marker corner with the reference point 312, with reference to the reference point 312. The computer 50 performs movement, rotation, or the like on the marker 381 so that the marker 381 is disposed to avoid the socket 321 provided on the wall surface.

For example, as shown in FIG. 18, the computer 50 translates the marker 381 disposed to match the upper left marker corner point with the reference point 312 in an upper left direction along the reference point 312, and disposes the marker 381 such that a lower right marker corner point matches the reference point 312. As a result, the marker 381 is displayed at a position that does not overlap with the socket 321, and the computer 50 can detect the marker 381.

As described above, in the third recovery process, the computer 50 performs movement, rotation, or the like on the marker 381 with reference to the reference point 312 corresponding to each marker 381, so that the marker 381, which has been displayed to overlap with the obstacle on the wall surface, can be disposed to avoid the obstacle. As a result, as in the case of the first recovery process, the projection position can be accurately adjusted by using more markers 381 for adjusting the projection position, and the efficiency of the registration work can be improved.

### <Fourth Recovery Process of Marker Detection>

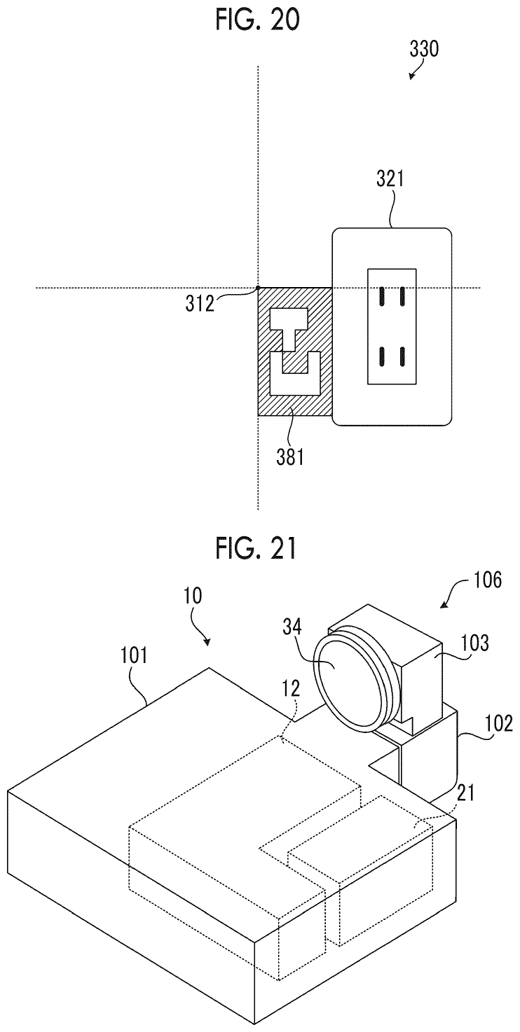

A fourth recovery process for detecting the marker image projected onto the projection object 6 will be described with reference to FIGS. 19 and 20. In the third recovery process, a case where movement, rotation, or the like is performed on the position of the marker 381 with reference to the reference point 312 in order to avoid the socket 321 provided at a position overlapping with the marker 381 has been described. However, in the fourth recovery process, a case where the overlapping with the socket 321 is avoided by changing the shape of the marker 381 will be described. The fourth recovery process is an example of the second detection process in step S17 of FIG. 7.

FIG. 19 is a diagram showing a partial captured image 330 obtained by capturing the first projected image 310 of FIG. 16. The computer 50 specifies the reference point 312 corresponding to the marker 381 for which the detection has failed in the capturing of the first projected image 310. The partial captured image 330 is a diagram showing the partial image of the region centered on the reference point 312 corresponding to the marker 381 for which the detection has failed.

As shown in FIG. 19, the embedded type socket 321 is provided around the reference point 312. On the other hand, the marker 381 is displayed at a position overlapping with the socket 321. Therefore, the computer 50 cannot detect the image of the marker 381 overlapping with the socket 321. The marker 381 is disposed to match the upper left marker corner point with the reference point 312.

FIG. 20 is a diagram showing an example of the marker 381 having the shape changed to avoid the socket 321. The computer 50 performs control of deforming the shape of the marker 381 disposed to match one point of the marker corner with the reference point 312, with reference to the reference point 312. The computer 50 deforms the marker 381 so that the marker 381 is disposed to avoid the socket 321.

For example, as shown in FIG. 20, the computer 50 changes the shape of the marker 381 disposed to match the upper left marker corner point with the reference point 312 such that a width in a left-right direction is narrowed and a width in an up-down direction is widened with reference to the reference point 312. As a result, the marker 381 is displayed at a position that does not overlap with the socket 321, and the computer 50 can detect the marker 381.

As described above, in the fourth recovery process, the computer 50 changes the shape of the marker 381, so that the marker 381 can be disposed to avoid the obstacle on the wall surface. As a result, as in the case of the first recovery process, the projection position can be accurately adjusted by using more markers 381 for adjusting the projection position, and the efficiency of the registration work can be improved.

### <Modification Example 1>

While the configuration in which the optical axis K is not bent has been described as the configuration of the projection device 10 in FIGS. 4 and 5, a configuration in which the optical axis K is bent once or more by providing a reflective member in the optical unit 106 may be adopted.

FIG. 21 is a schematic diagram showing another exterior configuration of the projection device 10. FIG. 22 is a schematic cross-sectional view of the optical unit 106 of the projection device 10 shown in FIG. 21. In FIGS. 21 and 22, the same parts as the parts shown in FIGS. 4 and 5 will be designated by the same reference numerals and will not be described.

As shown in FIG. 21, the optical unit 106 comprises a second member 103 supported by the first member 102 in addition to the first member 102 supported by the body part 101. The first member 102 and the second member 103 may be an integrated member.

As shown in FIG. 22, the optical unit 106 comprises, in addition to the first member 102, the second member 103 including a hollow portion 3A connected to the hollow portion 2A of the first member 102; the first optical system 121 and a reflective member 122 disposed in the hollow portion 2A; a second optical system 31, a reflective member 32, a third optical system 33, and the lens 34 disposed in the hollow portion 3A; the first shift mechanism 105; and a projection direction changing mechanism 104.

In the examples in FIGS. 21 and 22, the opening 2a and the opening 2b of the first member 102 are formed in surfaces perpendicular to each other. In addition, the optical projection system 23 shown in FIGS. 21 and 22 is composed of the reflective member 122, the second optical system 31, the reflective member 32, and the third optical system 33 in addition to the first optical system 121 and the lens 34 shown in FIGS. 4 and 5. With such an optical projection system 23, as shown in FIG. 22, the optical axis K is bent twice to be folded. The first optical system 121, the reflective member 122, the second optical system 31, the reflective member 32, the third optical system 33, and the lens 34 are disposed in this order from an optical modulation section 22 side along the optical axis K.

The first optical system 121 guides the light that is incident on the first member 102 from the body part 101 and that travels in the direction X1 to the reflective member 122. The reflective member 122 reflects the light incident from the first optical system 121 in the direction Y1. The reflective member 122 is composed of, for example, a mirror. In the first member 102, the opening 2b is formed on an optical path of the light reflected by the reflective member 122, and the reflected light travels to the hollow portion 3A of the second member 103 by passing through the opening 2b.

The second member 103 is a member having an approximately L-shaped cross-sectional exterior, in which an opening 3a is formed at a position facing the opening 2b of the first member 102. The light from the body part 101 that has passed through the opening 2b of the first member 102 is incident into the hollow portion 3A of the second member 103 through the opening 3a. The first member 102 and the second member 103 may have any cross-sectional exterior and are not limited to the above.

The second optical system 31 includes at least one lens and guides the light incident from the first member 102 to the reflective member 32. The reflective member 32 guides the light incident from the second optical system 31 to the third optical system 33 by reflecting the light in the direction X2. The reflective member 32 is composed of, for example, a mirror. The third optical system 33 includes at least one lens and guides the light reflected by the reflective member 32 to the lens 34.

The lens 34 closes an opening 3c formed in an end part of the second member 103 on a direction X2 side and is disposed in the end part. The lens 34 projects the light incident from the third optical system 33 to the projection object 6.

FIG. 22 shows the state where the first member 102 is moved as far as possible to the direction Y1 side by the first shift mechanism 105. By moving the first member 102 in the direction Y2 via the first shift mechanism 105 from the state shown in FIG. 22, the relative position between a center of the image formed by the optical modulation section 22 and the optical axis K changes, and the image G1 projected to the projection object 6 can be shifted in the direction Y1.

The projection direction changing mechanism 104 is a rotation mechanism that rotatably connects the second member 103 to the first member 102. By the projection direction changing mechanism 104, the second member 103 is configured to be rotatable about a rotation axis (specifically, the optical axis K) that extends in the direction Y. The projection direction changing mechanism 104 is not limited to a disposition position shown in FIG. 22 as long as the projection direction changing mechanism 104 can rotate the optical system. In addition, the number of rotation mechanisms is not limited to one, and a plurality of rotation mechanisms may be provided.

### <Modification Example 2>

While the computer 50 has been described as an example of the control device according to the embodiment of the present invention, the control device according to the embodiment of the present invention is not limited thereto. For example, the control device according to the embodiment of the present invention may be the first projection device 10a or the second projection device 10b. In this case, each control of the computer 50 is performed by the first projection device 10a or by the second projection device 10b. The first projection device 10a or the second projection device 10b may communicate with the imaging device 30 through the computer 50 or may communicate with the imaging device 30 without passing through the computer 50. In a case where the first projection device 10a or the second projection device 10b communicates with the imaging device 30 without passing through the computer 50, it may be configured to omit the computer 50 from the projection system 100.

Alternatively, the control device according to the embodiment of the present invention may be the imaging device 30. In this case, each control of the computer 50 is performed by the imaging device 30. The imaging device 30 may communicate with the first projection device 10a and the second projection device 10b through the computer 50 or may communicate with the first projection device 10a and the second projection device 10b without passing through the computer 50. In a case where the imaging device 30 communicates with the first projection device 10a or the second projection device 10b without passing through the computer 50, it may be configured to omit the computer 50 from the projection system 100.

### <Modification Example 3>

In addition, in the above-described example, a case where the plurality of marker images projected by the first projection device 10a and the plurality of marker images projected by the second projection device 10b have different colors and have the same arrangement and the same shape of the corresponding markers has been described. However, for example, the colors, the arrangements, and the shapes of both marker images may be different. In this case, the registration between the red marker image and the blue marker image is not performed and, for example, the registration is performed for each marker image of each color.

### <Modification Example 4>

In the above-described example, the case where the recovery process is applied to two projection devices (the first projection device 10a and the second projection device 10b) has been described, but the recovery process can be applied to, for example, one projection device. In that case, for example, the recovery process may be applied to the registration in which an end of the projection range projected from the projection device is caused to match an end of the wall that is the projection object 6.

### <Modification Example 5>

In a case where a marker that cannot be detected even after the above-described recovery process is executed remains, the position of the marker may be set by estimating, through linear interpolation or the like, a position of a reference point corresponding to the marker for which the detection has failed, based on the positions of the other markers in the periphery that is detected. As a result, it is possible to establish a series of automatic registrations for the entire projection. By establishing the series of automatic registrations, it is possible to improve efficiency of subsequent manual fine adjustment work.

### <Control Program>

The control method described in the above embodiment can be realized by executing a control program prepared in advance by a computer. The present control program is executed by being recorded in a computer-readable storage medium and being read out from the storage medium. In addition, the present control program may be provided in a form of being stored in a non-transitory storage medium, such as a flash memory, or may be provided via a network, such as the Internet. The computer that executes the present control program may be included in the control device, may be included in an electronic apparatus such as a smartphone, a tablet terminal, or a personal computer that can communicate with the control device, or may be included in a server device that can communicate with the control device and the electronic apparatus.

Although various embodiments have been described above, it is needless to say that the present invention is not limited to such examples. It is apparent that those skilled in the art may perceive various modification examples or correction examples within the scope disclosed in the claims, and those examples are also understood as falling within the technical scope of the present invention. In addition, each constituent in the embodiment may be used in any combination without departing from the gist of the invention.

The present application is based on Japanese Patent Application (JP2023-032759) filed on Mar. 3, 2023, the content of which is incorporated in the present application by reference.

### EXPLANATION OF REFERENCES

1: projection section
2: operation reception section
2A, 3A: hollow portion
2a, 2b, 3a, 3c, 15a: opening
4: control section
4a: storage medium
5: communication section
6: projection object
8a, 8b, 9: communication cable
10: projection device
10a: first projection device
10b: second projection device
11a, 11b: projection range
12: optical modulation unit
15: housing
21: light source
22: optical modulation section
23: optical projection system
24: control circuit
30: imaging device
31: second optical system
32, 122: reflective member
33: third optical system
34: lens
50: computer
51: processor
52: memory
53: communication interface
54: user interface
59: bus
80A, 310: first projected image
80B: second projected image
81, 381: marker
81u: upper stage marker
81m: middle stage marker
81l: lower stage marker
82, 82G, 82R: shadow
90A, 90B: red component captured image
90C: recovery marker image
100: projection system
101: body part
102: first member
103: second member
104: projection direction changing mechanism
105: first shift mechanism
106: optical unit
121: first optical system
201: R component
202: G component
203: B component
204, 205: wavelength range
210A: red-extracted captured image
210B: green-extracted captured image
220: projection position adjustment image
311: grid lattice
311H: horizontal grid
311V: vertical grid
312: reference point
320, 330: partial captured image
321: socket
G1: image

What is claimed is:

1. A control device comprising:
a processor,
wherein the processor is configured to
instruct a projection device to project a first image including a plurality of markers for adjusting a projection position,
perform a first detection process of detecting the plurality of markers based on first captured image data that is obtained by capturing a projection image of the first image, and
perform a second detection process of detecting, in a case where there is an undetected marker that is not detected in the first detection process, at least the undetected marker.

2. The control device according to claim 1,
wherein a color of the marker is a first color corresponding to a first wavelength range,
the processor is configured to perform, as the second detection process, a detection process of the undetected marker based on first color image data consisting of a component of the first color in the first captured image data and second color image data consisting of a component of a second color in the first captured image data, and
the second color is a color corresponding to a second wavelength range that partially overlaps with the first wavelength range.

3. The control device according to claim 2,
wherein the processor is configured to perform the detection process of the undetected marker based on a subtraction process between the first color image data and the second color image data.

4. The control device according to claim 3,
wherein the processor is configured to
calculate a coefficient based on the first color image data and the second color image data, and
perform the detection process of the undetected marker based on the subtraction process between the first color image data and the second color image data that is corrected by the coefficient.

5. The control device according to claim 1,
wherein the processor is configured to, as the second detection process,
instruct the projection device to project a second image including a marker obtained by excluding the undetected marker from the plurality of markers, and
perform a detection process of the undetected marker based on the first captured image data and second captured image data that is obtained by capturing a projection image of the second image.

6. The control device according to claim 5,
wherein the processor is configured to perform the detection process of the undetected marker based on a subtraction process between the first captured image data and the second captured image data.

7. The control device according to claim 1,
wherein the processor is configured to, as the second detection process,
instruct the projection device to project a third image including a plurality of markers in which at least any one of a position, an orientation, or a shape is different from a position, an orientation, or a shape of the plurality of markers in the first image, and
perform a detection process of the undetected marker based on third captured image data that is obtained by capturing a projection image of the third image.

8. The control device according to claim 7,
wherein the plurality of markers included in the third image are disposed to avoid a thing present on a projection surface for the projection image of the first image.

9. The control device according to claim 8,
wherein the processor is configured to detect the thing based on the first captured image data.

10. The control device according to claim 7,
wherein there are reference points corresponding to the plurality of markers in the first image, and
the plurality of markers in the third image are in a relationship, in which at least any one of movement, rotation, or deformation is performed on at least the undetected marker in the first image with reference to the reference points, with the undetected marker.

11. A projection system comprising the control device according to claim 1 and a projection device.

12. A control method of a control device including a processor, the control method comprising:
instructing a projection device to project a first image including a plurality of markers for adjusting a projection position,
performing a first detection process of detecting the plurality of markers based on first captured image data that is obtained by capturing a projection image of the first image, and
performing a second detection process of detecting, in a case where there is an undetected marker that is not detected in the first detection process, at least the undetected marker.

13. A non-transitory computer-readable medium storing a control program of a control device for causing a processor of the control device to execute a process comprising:
instructing a projection device to project a first image including a plurality of markers for adjusting a projection position,
performing a first detection process of detecting the plurality of markers based on first captured image data that is obtained by capturing a projection image of the first image, and
performing a second detection process of detecting, in a case where there is an undetected marker that is not detected in the first detection process, at least the undetected marker.
